(19) United States
(12) Patent Application Publication
(10) Pub. No.: US 2022/0252393 A1
(43) Pub. Date: Aug. 11, 2022

(54) SENSOR, MOVABLE PLATFORM AND MICROWAVE RADAR SENSOR

(71) Applicant: SZ DJI TECHNOLOGY CO., LTD., Shenzhen (CN)

(72) Inventors: Wanren ZHOU, Shenzhen (CN); Wenkang ZHANG, Shenzhen (CN)

(73) Assignee: SZ DJI TECHNOLOGY CO., LTD., Shenzhen (CN)

(21) Appl. No.: 17/731,499

(22) Filed: Apr. 28, 2022

Related U.S. Application Data
(63) Continuation of application No. PCT/CN2019/115437, filed on Nov. 4, 2019.

(51) Int. Cl. G01B 11/26; G01B 7/00; G01S 17/88; G01S 13/86; H02N 2/16

(52) U.S. Cl. CPC G01B 11/26; G01B 7/003; G01D 5/34738; G01S 13/865; H02N 2/163; G01S 17/88

(57) ABSTRACT

A sensor, a movable platform, and a microwave radar sensor are provided. The sensor may include a motor, a rotating body, and a grating sensor. The motor may include a stator and a rotor rotatably connected to the stator, and the stator may have a mounting end face in an extension direction of a rotation center line of the rotor. The rotating body may be fixedly connected to the rotor. The grating sensor may include a grating code disc and a reading head assembly matched with the grating code disc. The grating code disc may be disposed on the mounting end face. The reading head assembly may be connected to the rotating body, and its position is opposite the position of the grating code disc. The reading head assembly may cooperate with the grating code disc to sense a rotation angle of the rotating body.

### CROSS-REFERENCE TO RELATED APPLICATION

The present application is a continuation of International Application No. PCT/CN2019/115437, filed Nov. 4, 2019, the entire contents of which being incorporated herein by reference in its entirety.

### TECHNICAL FIELD

The present disclosure relates to the technical field of remote sensing equipment, and particularly relates to a sensor, a movable platform, a microwave radar sensor.

### BACKGROUND

Radar is an active remote sensing device that is extensively applied to unmanned aerial vehicles and automobile vehicles to realize the obstacle avoidance function of unmanned aerial vehicle and automobile vehicle.

### SUMMARY

According to one aspect of the present disclosure, a sensor is provided, the sensor including:

a motor, the motor including a stator and a rotor rotatably connected to the stator, the stator having a mounting end face in an extension direction of a rotation center line of the rotor;

a rotating body, the rotating body being fixedly connected to the rotor; and

a grating sensor, the grating sensor including a grating code disc and a reading head assembly matched with the grating code disc, where the grating code disc is arranged on the mounting end face; the reading head assembly is connected with the rotating body, and a position of the reading head assembly is opposite a position of the grating code disc,

wherein the reading head assembly cooperates with the grating code disc to sense a rotation angle of the rotating body.

According to another aspect of the present disclosure, a movable platform is provided, the movable platform including a movable body and a sensor provided on the movable platform body. The sensor may include:

a motor, the motor including a stator and a rotor rotatably connected to the stator, the stator having a mounting end face in an extension direction of a rotation center line of the rotor;

a rotating body, the rotating body being fixedly connected to the rotor; and

a grating sensor, the grating sensor including a grating code disc and a reading head assembly matched with the grating code disc, where the grating code disc is arranged on the mounting end face; the reading head assembly is connected with the rotating body, and a position of the reading head assembly is opposite a position of the grating code disc,

wherein the reading head assembly cooperates with the grating code disc to sense a rotation angle of the rotating body.

According to yet another aspect of the present disclosure, a microwave sensor is provided, the microwave sensor including:

a motor, the motor including a stator and a rotor rotatably connected to the stator, the stator having a mounting end face in an extension direction of a rotation center line of the rotor;

a grating code disc, the grating code disc arranged on the mounting end face and having a plurality of reflective areas spaced at intervals along the circumferential direction of the grating code disc;

a rotating body, the rotating body being fixedly connected to the rotor; and

a reading head assembly, the reading head assembly connected to the rotating body, where a position of the reading head assembly is opposite a position of the grating code disc, wherein the reading head assembly cooperates with the grating code disc to sense a rotation angle of the rotating body.

In the technical scheme provided by some embodiments of the present disclosure, the grating code disc is arranged on the stator, the reading head assembly is connected with the rotating body, and the position of the reading head assembly corresponds to the position of the grating code disc. The grating code disc and the reading head assembly are embedded in the space occupied by the stator, so that the structural layout of the sensor is more reasonable and compact, the space utilization is greatly improved, which effectively reduces the space occupied by the sensor.

It should be understood that the above general description and the following detailed description are only exemplary and explanatory and are not restrictive of the present disclosure.

### BRIEF DESCRIPTION OF THE DRAWINGS

In order to explain the technical features of embodiments of the present disclosure more clearly, the drawings used in the present disclosure are briefly introduced as follow. Obviously, the drawings in the following description are some exemplary embodiments of the present disclosure. Ordinary person skilled in the art may obtain other drawings and features based on these disclosed drawings without inventive efforts. Non-limiting examples of the present disclosure are shown in figures, wherein:

FIG. 1 illustrates a schematic structural diagram of a sensor according to some embodiments of the present disclosure;

FIG. 2 illustrates a schematic diagram of a cross-sectional structure of a sensor according to some embodiments of the present disclosure;

FIG. 3 illustrates an enlarged schematic diagram of area A of FIG. 2;

FIG. 4 illustrates a schematic bottom view of a sensor according to some embodiments of the present disclosure;

FIG. 5 illustrates an enlarged schematic diagram of area B of FIG. 4;

FIG. 6 illustrates a schematic structural diagram of a reading head assembly according to some embodiments of the present disclosure;

FIG. 7 illustrates a schematic structural diagram of a rotating body according to some embodiments of the present disclosure;

FIG. 8 illustrates an enlarged schematic diagram of area C of FIG. 7;

FIG. 9 illustrates a schematic diagram of a cross-sectional structure of a rotating body according to some embodiments of the present disclosure; and

FIG. 10 illustrates an enlarged schematic view of area D of FIG. 9.

### DETAILED DESCRIPTION

The technical solutions and technical features encompassed in the exemplary embodiments of the present disclosure will be described in detail in conjunction with the accompanying drawings in the exemplary embodiments of the present disclosure. In the case of no conflict, the following embodiments and features in the embodiments can be combined with each other. Apparently, the described exemplary embodiments are part of embodiments of the present disclosure, not all of the embodiments. Based on the embodiments and examples disclosed in the present disclosure, all other embodiments obtained by those of ordinary skill in the art without inventive efforts shall fall within the protection scope of the present disclosure.

In the radar device currently used, the structural layout of the existing encoder takes up a lot of space, which leads to an increase in the overall structure of the radar device. The reason is that the transmitter and receiver of the currently used encoders are usually separated and most of the grating code discs connected to the rotating parts are large in size, which causes the entire encoder system to occupy a large space. The increase in size results in an increase in the overall structure of the radar device, which is not conducive to the miniaturization and lightweight of the whole device.

To address the above and other problems, some embodiments of the present disclosure provide a sensor and a movable platform. The structural layout of the sensor is more reasonable and compact, which greatly improves the space utilization and effectively reduces the space occupied by the sensor.

### EXAMPLE 1

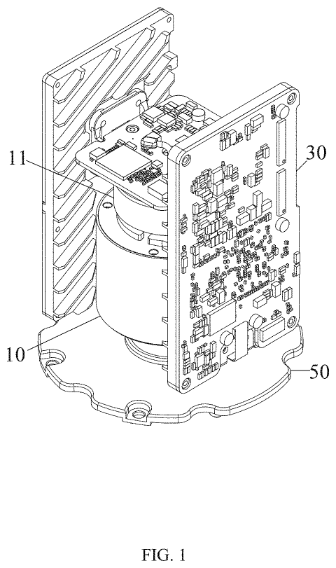

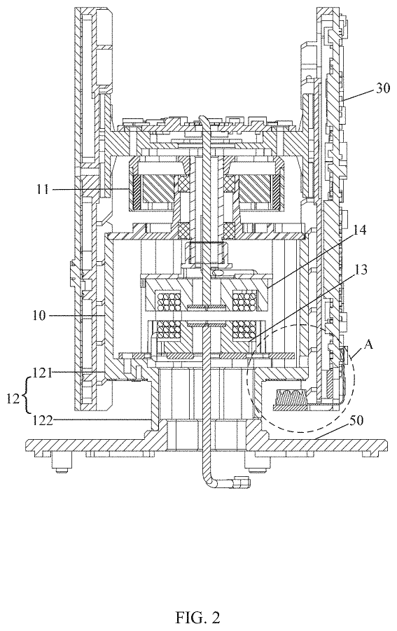

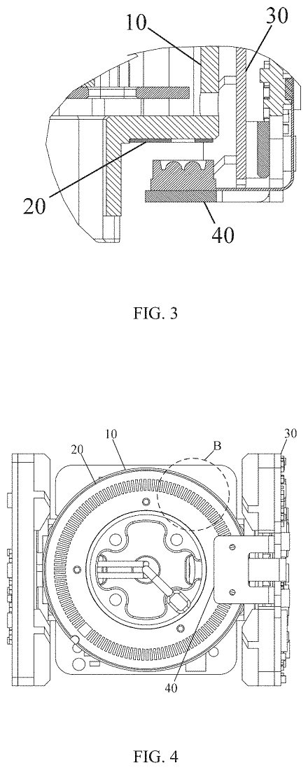

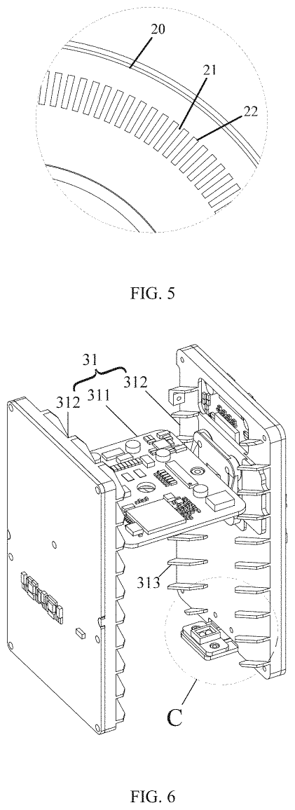

FIG. 1 illustrates a schematic structural diagram of a sensor according to some embodiments of the present disclosure; FIG. 2 illustrates a. schematic diagram of a cross-sectional structure of a sensor according to some embodiments of the present disclosure; FIG. 3 illustrates an enlarged schematic diagram of area A of FIG. 2; FIG. 4 illustrates a schematic bottom view of a sensor according to some embodiments of the present disclosure; and FIG. 5 illustrates an enlarged schematic diagram of area B of FIG. 4. As shown in FIG. 1 to FIG. 5, in one embodiment, the present disclosure provides a sensor. The sensor may include a motor, a rotating body 30, and a grating sensor. The motor is configured to drive the rotating body 30 to rotate. The grating sensor is configured to sense the rotation angle of the rotating body 30. The grating sensor may include a grating code disc 20 and a reading head assembly 40 matched with the grating code disc 20. The grating sensor may be a reflective grating sensor, a transmissive grating sensor, or the like.

Referring to FIG. 1 and FIG. 2, the motor may include a stator 10 and a rotor 11 rotatably connected with the stator 10. The stator 10 may have a mounting end face in the extension direction of the rotation center line of the rotor 11. The rotating body 30 may be fixedly connected to the rotor 11. As shown in FIG. 3, the grating code disc 20 is arranged on the mounting end face. As shown in FIGS. 4 and 5, in some embodiments, the grating code disc 20 may be a reflective grating code disc. The grating code disc 20 has a plurality of reflective areas 21 spaced at intervals along the circumferential direction of the grating code disc 20.

Referring to FIG. 3, in some embodiments, the reading head assembly 40 may be a reading head of a reflective grating sensor. The reading head assembly 40 is connected to the rotating body 30 and the position of the reading head assembly 40 corresponds to or is opposite the position of the grating code disc 20. As shown in FIGS. 2 and 3, the grating code disc 20 is arranged on the mounting end face. In order to realize that the reading head assembly 40 opposites the grating code disc 20, the reading head assembly 40 needs to extend toward the extension direction of the rotation center line of the rotor 11, and the reading head assembly 40 faces the grating code disc 20. The reading head assembly 40 may transmit an optical signal to the grating code disc 20 and receive the optical signal reflected by the reflective areas 21. The reading head assembly 40 cooperates with the grating code disc 20 to sense the rotation angle of the rotating body 30.

It should be noted that in other embodiments, the grating sensor may be a transmissive grating sensor, the grating code disc 20 may be a transmissive grating code disc, and the reading head assembly 40 may include a reading head of the transmissive grating sensor.

Taking the reading head assembly 40 as a reading head of a reflective grating sensor as an example, when in use, the rotor 11 of the motor rotates, it may drive the rotating body 30 to rotate. When the rotating body 30 rotates, the reading head assembly 40 is driven to rotate around the grating code disc 20. In one embodiment, the reading head assembly 40 may include a light emitting end for transmitting an optical signal to the grating code disc 20 and a light receiving end for receiving the optical signal reflected by the reflective areas 21. When the reading head assembly 40 rotates, light is emitted through the light emitting end, and when the reading head assembly 40 is located in the reflective areas 21, the light receiving end receives the optical signal reflected from the reflective areas 21, so that the grid may be determined based upon the magnitude of the reflected optical signal, thereby knowing the relative position of the rotating body 30 and accordingly the rotation angle of rotating body 30. It should be noted that the determination of the grid based upon the magnitude of the reflected optical signal so that the relative position of the rotating body 30 may be known may be implemented according to the existing technology, which will not be described in detail herein.

In the technical scheme provided by some embodiments of the present disclosure, the grating code disc 20 is arranged on the stator 10, and the reading head assembly 40 is connected to the rotating body 30 and its position corresponds to or is opposite the position of the grating code disc 20. The reading head assembly 40 extends toward the direction of the rotation center line of the rotor 11. The grating code disc 20 and the reading head assembly 40 are embedded in the space occupied by the stator 10, which makes the structural layout of the sensor more sensible and greatly improves the space utilization, thereby effectively reducing the space occupied by the sensor. In one embodiment, in a plan view, the grating code disk and the read head assembly are located in a space within the stator. In some embodiments of the present disclosure, the sensor may include, but is not limited to, a microwave radar, a millimeter wave radar, or a lidar. It is also suitable for other application fields that require angular servo control.

Continuing to refer to FIG. 1 and FIG. 2, to facilitate the installation of the sensor, the sensor may further include a connecting base 50, which is connected to the stator 10. The connecting base 50 may be used to install the sensor in different application positions. For example, the sensor may be installed on an unmanned aerial vehicle, a car, or a mobile robot through the connection base 50.

Further, in some embodiments of the present disclosure, the implementation approach of the mounting end face may include, but is not limited to, the following approaches: referring to FIG. 2, one implementation approach is that the mounting end face is an end face of the stator 10 facing away the rotor 11, and another implementation approach is that the mounting end face is an end face of the stator 10 facing the rotor 11.

For example, when the sensor is in use, the rotor 11 needs to drive the rotating body 30 to rotate. In order to prevent the rotating body 30 from touching a mounting face when the rotating body 30 rotates, in certain embodiments, certain first avoidance space is left between the end face of the stator 10 facing away from the rotor 11 and the mounting face. The first avoidance space is used to make the rotating body 30 far away from the mounting face. In one embodiment, when the connecting base 50 is provided, certain first avoidance space is reserved between the stator 10 and the connecting base 50. In order to make rational use of the first avoidance space here, the reading head assembly 40 is embedded in the first avoidance space, the end face of the stator 10 facing away from the rotor 11 is used as the mounting end face, and the grating code disc 20 is installed on the end face of the stator 10 facing away from the rotor 11, so as to save the space occupied by the sensor.

Another way to prevent the rotating body 30 from touching the mounting face when rotating is to leave certain second avoidance space between the end face of the stator 10 facing the rotor 11 and the rotor 11, and the rotating body 30 is kept away from the mounting face through the second avoidance space. In order to make reasonable use of the second avoidance space here, in some embodiments of the present disclosure, the reading head assembly 40 is embedded in the second avoidance space, the end face of the stator 10 facing the rotor 11 is used as the mounting end face. The grating code disc 20 is installed on the end face of the stator 10 facing the rotor 11 in order to save the space occupied by the sensor.

In addition to the above approaches, the implementation approach of the mounting end face may also include the following manner. Continue to refer to FIG. 2. In one embodiment of the present disclosure, a base 12 is provided on the stator 10. The base 12 may be used as a part of the stator 10 and is located at an end of the stator 10 away from the rotor 11. The base 12 may include a bearing platform 121 and a connecting frame 122 arranged on the bearing platform 121. The bearing platform 121 is connected to the end face of the stator 10 facing away from the rotor 11, and an end face of the bearing platform 121 facing away from the stator 10 is the mounting end face. The stator 10 may be connected to the mounting face through the connecting frame 122 of the base 12. For example, when the connecting base 50 is provided, the stator 10 is connected to the connecting base 50 through the connecting frame 122. The connecting frame 122 may prevent the rotating body 30 from touching the mounting face when rotating, so that there is certain third avoidance space between the end face of the bearing platform 121 facing away from the stator 10 and the mounting surface. The third avoidance space males the rotating body 30 far away from the mounting surface. In one embodiment, the connecting base 50 is provided, certain third avoidance space is left between the end face of the bearing platform 121 facing away from the stator 10 and the connecting base 50. In order to make a reasonable use of the third avoidance space here, in the instance embodiment, the reading head assembly 40 is embedded in the third avoidance space, the end face of the bearing platform 121 facing away from the stator 10 is used as the mounting end face. The grating code disc 20 is installed on the end face of the bearing platform 121 facing away from the stator 10 in order to save the space occupied by the sensor.

Further, in order to better meet the requirements of the reading head assembly 40 on the difference in reflectivity, as shown in FIG. 4 and FIG. 5, in some embodiments, a non-reflective area 22 may be provided between two adjacent reflective areas 21 on the grating code disc 20. For example, the grating code disc 20 may include, but is not limited to, being made of metal materials. The whole of the grating code disc 20 or at least the position corresponding to the reflective area 21 is processed by a polishing process, so that the grating code disc 20 may have an integral reflective surface. A plurality of non-reflective areas 22 are provided along the circumferential direction of the outer circumference of the reflective surface, so that a plurality of reflective areas 21 are separated by the non-reflective areas 22. That is, a non-reflective area 22 is provided between two adjacent reflective areas 21. The non-reflective area 22 may be formed by a blackening process or a paint-blackening process. For example, a plurality of black non-reflective areas 22 may be formed on the reflective surface through a metal blackening oxidation process or a surface black paint painting process.

In some embodiments, for example, a reflective material may be provided on the grating code disc 20 at least at the position corresponding to the reflective area 21 to form the reflective area 21, A non-reflective area 22 is provided on the grating code disc 20 with the reflective area 21, so that there is a non-reflective area 22 between two adjacent reflective areas 21.

Of course, the non-reflective area 22 may be provided on the grating code disc 20 first, and then the reflective area 21 is provided. For example, the grating code disc 20 is made of metal material, and the entire grating code disc 20 or at least the position corresponds to the non-reflective area 22 is treated by a metal blackening oxidation process to form the non-reflective area 22. A spaced reflective region 21 is formed on the non-reflective area 22 by a polishing process.

In some embodiments, to better meet the requirements of the reading head assembly 40 on the difference in reflectivity, a through hole is provided between two adjacent reflective areas 21 on the grating code disc 20, a non-reflective area 22 is provided in the area corresponding to the through hole on the mounting end face. For example, the grating code disc 20 may include, but is not limited to, being made of a metal material. The whole of the grating code disc 20 or at least the position corresponding to the reflective area 21 is processed by a polishing process, so that the grating code disc 20 has an integral reflective surface. A plurality of through holes are provided along the circumferential direction of the outer circumference of the reflective surface, so that a plurality of reflective areas 21 are separated by the through holes. In certain embodiments, a reflective material may be provided on the grating code disc 20 at least at a position corresponding to the reflective area 21 to form the reflective area 21.

The entire mounting end face or the area corresponding to the through hole may be processed by a blackening process or a paint-blackening process to form a non-reflective area 22. For example, a black non-reflective area 22 is formed on the mounting end face through a metal blackening oxidation process or a surface black paint painting process.

With the coordination of the grating code disc 20 with the through hole and the black mounting end face may better meet the requirements of the grating code disc 20 on the difference in reflectivity, so that the reading head assembly 40 may receive the reflected optical signal more accurately, thereby making the sensor operation more accurate.

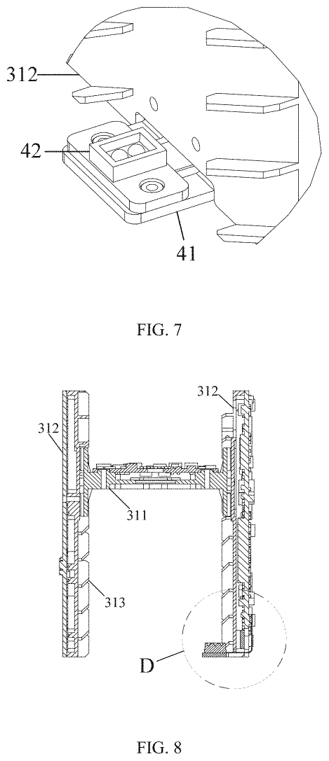

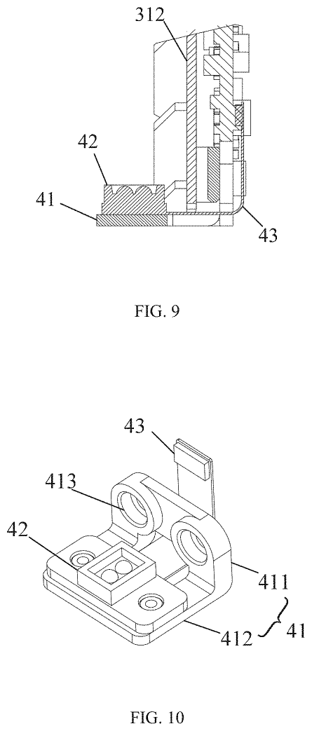

FIG. 6 illustrates a schematic structural diagram of a reading head assembly according to some embodiments of the present disclosure; 7 illustrates a schematic structural diagram of a rotating body according to some embodiments of the present disclosure; FIG. 8 illustrates an enlarged schematic diagram of area C of FIG. 7; FIG. 9 illustrates a schematic diagram of a cross-sectional structure of a rotating body according to some embodiments of the present disclosure; and FIG. 10 illustrates an enlarged schematic view of area D of FIG. 9. As shown in FIG. 6, in some embodiments of the present disclosure, the rotating body 30 may include a support frame 31 and a circuit system provided on the support frame 31 (the circuit system is not shown in the figure). The support frame 31 is connected to the rotor 11. The reading head assembly 40 is arranged on the support frame 31 and is electrically connected to the circuit system. The signal read by the reading head assembly 40 is transmitted to the circuit system of the rotating body 30, and the circuit system on the rotating body 30 completes the processing and transmission of the signal.

Referring back to FIG. 2, in order to realize the power supply and data transmission of the circuit system, in some embodiments of the present disclosure, a wireless power supply assembly 13 and a data transmission assembly 14 are provided in the motor. The wireless power supply assembly 13 is respectively coupled to the data transmission assembly 14, the circuit system of the rotating body 30 and the reading head assembly 40, and supplies electric power to the data transmission assembly 14, the circuit system and the reading head assembly 40 through wireless power supply. The data transmission assembly 14 is coupled to the circuit system of the rotating body 30, and transmits data signals for the circuit system through wireless transmission.

Referring to FIGS. 1, 6 and 8, in some embodiments of the present disclosure, the support frame 31 may include a middle connecting plate 311 and side plates 312 provided at opposite ends of the middle connecting plate 311. The motor is arranged between the two side plates 312 and is fixedly connected to the middle connecting plate 311 through the rotor 11. The reading head assembly 40 is connected to a side plate 312. The motor is inserted and extends between the two side plates 312, which may effectively reduce the space occupied by the sensor in the vertical direction. The rotor 11 and the stator 10 of the motor are both in the space formed when the rotating body 30 rotates, so no additional space is occupied. The overall volume of the sensor is reduced. It is more convenient to apply the sensor to volume-sensitive equipment, which increases the application range of the sensor.

In order to reasonably distribute the circuit system and avoid the situation that the circuit system is located on one board and generates heat concentration, in some embodiments of the present disclosure, at least one sub-circuit is provided on the middle connecting plate 311 and the two side plates 312 respectively, and each sub-circuit is coupled to each other to form the circuit system. The circuit system is dispersedly arranged so that there is no heat concentration, and the heat dissipation effect is improved.

Furthermore, in order to better dissipate heat for the motor and the circuit system, in some embodiment, a plurality of cooling fins 313 are provided on the side of the side plate 312 facing the motor. The heat generated by the circuit system may be quickly dissipate to the environment through the cooling fins 313, thereby improving the heat dissipation efficiency. Of course, the side of the middle connecting plate facing the motor may also be provided with a plurality of cooling fins 313, which is not limited herein.

Referring to FIG. 10, in some embodiments of the present disclosure, the reading head assembly 40 may include a mounting bracket 41, a reading head 42 and an electrical connector 43. Referring to FIGS. 7 and 9, the mounting bracket 41 is connected to the rotating body 30. The reading head 42 is arranged on the mounting bracket 41 and extends toward the extension direction of the rotation center line of the rotor 11, and the reading head 42 is electrically connected to the rotating body 30 through an electrical connector 43. The signal read by the reading head 42 is transmitted to the circuit system of the rotating body 30 through the electrical connector 43. The electrical connector 43 may include, but is not limited to, a flexible circuit board (FPC). The reading head 42 is connected to the mounting bracket by a fastener, including, but is not limited to, for example, a screw.

In some embodiments, the reading head 42 may include a light emitting end, a light receiving end and a signal processor. The light transmitting end may be configured to transmit an optical signal to the grating code disc 20, and the light receiving end may be configured to receive the optical signal reflected by the reflective area 21. The signal processor is connected to the light receiving end, and converts the optical signal received by the light receiving end into an electrical signal, and sends the electrical signal to the rotating body 30 through the electrical connector 43. The light emitting end and the light receiving end are integrated, which may effectively reduce the volume of the reading head 42, thereby reducing the volume of the sensor.

Furthermore, in some embodiments, the mounting bracket 41 may include a first connecting plate 411 and a second connecting plate 412. The first connecting plate 411 is connected to the rotating body 30. The second connecting plate 412 is connected to the first connecting plate 411 and extends toward the extension direction of the rotation center line of the rotor 11. The first connecting plate 411 and the second connecting plate 412 may be an integral structure. To facilitate the extension of the second connecting plate 412 toward the rotation centerline of the rotor 11, the first connecting plate 411 and the second connecting plate 412 may form an L-shaped structure. The first connecting plate 411 is connected to the rotating body 30 by a fastener such as a screw, and the reading head 42 is arranged on the second connecting plate 412, and the reading head 42 is extended toward the extension direction of the rotation center line of the rotor 11 through the second connecting plate 412.

To further facilitate the connection of the electrical connector with the circuit system on the rotating body 30, in some embodiments, the mounting bracket 41 may have a through hole 413. One end of the electrical connector 43 is connected to the reading head 42, and the other end passes through the through hole 413 to electrically connect to the rotating body 30. Through the through hole 413, the wiring length of the electrical connector may be reduced, that is, the length of the transmission path between the electrical connector and the circuit system may be shortened, signal loss may be reduced, and signal transmission accuracy is improved.

### EXAMPLE 2

On the basis of EXAMPLE 1, some embodiments of the present disclosure also provide a movable platform. The movable platform may include a movable platform body and a sensor provided on the movable platform body. The sensor may be any one of the sensors disclosed above.

In some embodiments, the movable platform may include a movable platform body and a sensor arranged on the movable platform body.

The sensor may include a motor, a rotating body 30 and a grating sensor. The motor may include a stator 10 and a rotor 11 rotatably connected to the stator 10. The stator 10 may have a mounting end face in the extension direction of the rotation center line of the rotor 11. The rotating body 30 is fixedly connected to the rotor 11. The grating sensor may include a grating code disc 20 and a reading head assembly 40 matched with the grating code disc 20. The grating code disc 20 is arranged on the mounting end face. The reading head assembly 40 is connected to the rotating body 30 and its position corresponds to the position of the grating code disc 20. The reading head assembly 40 cooperates with the grating code disc 20 to sense the rotation angle of the rotating body 30.

The technical scheme provided by some embodiments of the present disclosure may realize the obstacle avoidance function of the movable platform through the sensor. The grating code disc 20 is arranged on the stator 10, and the reading head assembly 40 is connected to the rotating body 30 and its position corresponds to the position of the grating code disc 20. The reading head assembly 40 extends toward the direction of the rotation center line of the rotor 11, and the grating code disc 20 and the reading head assembly 40 are embedded in the space occupied by the stator 10, which makes the structural layout of the sensor more reasonable and compact and greatly improves the space utilization, thereby effectively reducing the space occupied by the sensor. The overall volume of the sensor is smaller, which makes it easier to apply the sensor on a volume-sensitive movable platform, thereby increasing the application range of the sensor.

In some embodiments of the present disclosure, the movable platform may be, but is not limited to, an unmanned aerial vehicle, an unmanned vehicle, or a movable robot.

It should be noted that the technical schemes of the related sensors described in the instance example and the technical schemes disclosed in EXAMPLE 1 may be referred to each other for reference and will not be repeated herein for conciseness.

### EXAMPLE 3

On the basis of EXAMPLE 1, some embodiments of the present disclosure further provide a microwave radar sensor. The implementation manners and technical effects of the instant microwave radar sensor are similar to those in the sensor embodiments disclosed above, therefore, the components in the microwave radar sensor may refer to the relevant components in the sensor described in EXAMPLE 1 above.

In some embodiments, referring to FIGS. 1 to 5, the microwave radar sensor may include a motor, a grating code disc 20, a rotating body 30 and a reading head assembly 40. The motor may include a stator 10 and a rotor 11. rotatably connected to the stator 10. The stator 10 may have a mounting end face toward the extension direction of the rotation center line of the rotor 11 The grating code disc 20 is arranged on the mounting end face, and the grating code disc 20 has a plurality of reflective areas 21 distributed at intervals along the circumferential direction of the grating code disc 20. The rotating body 30 is fixedly connected to the rotor 11. And the reading head assembly 40 is connected to the rotating body 30, and its position corresponds to the position of the grating code disc 20. The reading head assembly 40 cooperates with the grating code disc 20 to sense the rotation angle of the rotating body 30.

In some embodiments of the present disclosure, the motor is configured to drive the rotating body 30 to rotate. Referring to FIG. 3, in some embodiments, the reading head assembly 40 may be a reading head of a reflective grating sensor. Referring to FIGS. 4 and 5, in some embodiments, the grating code disc 20 may be a reflective grating code disc. The grating code disc 20 has a plurality of reflective areas 21 spaced at intervals along the circumferential direction of the grating code disc 20. As shown in FIGS. 2 and 3, the grating code disc 20 is arranged on the mounting end face. In order to realize that the reading head assembly 40 corresponds to the grating code disc 20, the reading head assembly 40 extends toward the extension direction of the rotation center line of the rotor 11, and the reading head assembly 40 faces the grating code disc 20. The reading head assembly 40 may transmit an optical signal to the grating code disc 20 and receive the optical signal reflected by the reflective area 21. The reading head assembly 40 cooperates with the grating code disc 20 to sense the rotation angle of the rotating body 30.

In other embodiments, the grating code disc 20 may be a transmissive grating code disc, accordingly, the reading head assembly 40 may include a reading head of a transmissive grating sensor.

Taking the reading head assembly 40 as a reflective grating sensor as an example, the reading head assembly 40 may include a light emitting end and a light receiving end. The light emitting end is configured to transmit an optical signal to the grating code disc 20, and the light receiving end is configured to receive the optical signal reflected from the reflective area 21. When the microwave radar sensor in use, the rotor 11 of the motor rotates, it drives the rotating body 30 to rotate. When the rotating body 30 rotates, the reading head assembly 40 is driven to rotate around the grating code disc 20. When the reading head assembly 40 rotates, light is emitted through the light emitting end. When the reading head assembly 40 is located in the reflective area 21, the light receiving end receives the optical signal reflected from the reflective area 21, so that the grid may be determined based upon the magnitude of the reflected optical signal, so as to know the relative position of the rotating body 30.

In the technical schemes provided by some embodiments of the present disclosure, the grating code disc 20 is arranged on the stator 10. The reading head 42 is connected to the rotating body 30, and its position corresponds to the position of the grating code disc 20. The reading head assembly 40 extends toward the direction of the rotation center line of the rotor 11, and the grating code disc 20 and the reading head assembly 40 are embedded in the space occupied by the stator 10, which makes the structural layout of the microwave radar sensor more reasonable and compact and greatly improves the space utilization, thereby effectively reducing the space occupied by microwave radar sensors. The overall size of the microwave radar sensor is small, which makes it more convenient to apply the microwave radar sensor on a movable platform that is sensitive to volume, thereby increasing the application range of the microwave radar sensor.

It should be noted that the technical schemes and technical effects of the related microwave radar sensor described in EXAMPLE 3 are similar to the technical schemes and technical effects of the sensor described in EXAMPLE 1, therefore, the components in the microwave radar sensor may refer to the relevant components in the sensor described in EXAMPLE 1 above. In summary, in the technical schemes provided by the present disclosure, the grating code disc is arranged on the stator, and the reading head assembly is connected to the rotating body and the position of the reading head assembly corresponds to or face the position of the grating code disc. The reading head assembly extends toward the direction of the rotation center line of the rotor, and the grating code disc and the reading head assembly are embedded in the space occupied by the stator, which makes the sensor structure more reasonable and compact, greatly improves the space utilization, and effectively reduces the space occupied by the sensor. On the other hand, the overall size of the sensor is smaller, which makes it more convenient to apply the sensor on a volume-sensitive movable platform, thereby increasing the application range of the sensor.

Unless otherwise defined, all technical and scientific terms used herein have the same meaning as commonly understood by those skilled in the technical field of the present disclosure. The terms used herein are only for the purpose of describing specific embodiments and are not intended to limit of the disclosure. As used in this disclosure and the appended claims, the singular forms “a,” “an,” and “the” are intended to include the plural forms as well, unless the context clearly indicates otherwise. It should also be understood that the term “and/or” as used herein refers to and encompasses any or all possible combinations of one or more associated listed items. Terms such as “connected” or “linked” are not limited to physical or mechanical connections, and may include electrical connections, whether direct or indirect. Phrases such as “a plurality of,” “multiple,” or “several ” mean two and more.

It should be noted that in the instant disclosure, relational terms such as “first” and “second”, etc. are used herein merely to distinguish one entity or operation from another entity or operation without necessarily requiring or implying any such actual relationship or order between such entities or operations. The terms “comprise/comprising”, “include/including”, “has/have/having” or any other variants thereof are intended to cover non-exclusive inclusion, so that a process, method, article, or device that includes a series of elements includes not only those elements, but also other elements that are not explicitly listed, or also includes elements inherent to such processes, methods, articles, or equipment. If there are no more restrictions, the element defined by the phrase, such as “comprising a . . . ”, “including a . . . ” does not exclude the presence of additional identical elements in the process, method, article, or equipment that includes the element.

Finally, it should be noted that the above embodiments/examples are only used to illustrate the technical features of the present disclosure, not to limit them; although the present disclosure has been described in detail with reference to the foregoing embodiments and examples, those of ordinary skill in the art should understand that: the technical features disclosed in the foregoing embodiments and examples can still be modified, some or all of the technical features can be equivalently replaced, but, these modifications or replacements do not deviate from the spirit and scope of the disclosure.

What is claimed is:

1. A sensor, comprising:
a motor, the motor comprising a stator and a rotor rotatably connected to the stator, the stator having a mounting end face in an extension direction of a rotation center line of the rotor;
a rotating body, the rotating body being fixedly connected to the rotor; and
a grating sensor, the grating sensor comprising a grating code disc and a reading head assembly matched with the grating code disc,
wherein the grating code disc is disposed on the mounting end face of the stator, the reading head assembly is connected to the rotating body, and a position of the reading head assembly is opposite a position of the grating code disc; and
wherein the reading head assembly cooperates with the grating code disc to sense a rotation angle of the rotating body.

2. The sensor of claim 1, wherein the grating code disc comprises a plurality of reflective areas distributed at intervals along a circumferential direction of the grating code disc; and
the reading head assembly transmits an optical signal to the grating code disc and receives the optical signal reflected by the reflective areas.

3. The sensor of claim 1, wherein the mounting end face is an end face of the stator facing away from the rotor or an end face of the stator facing the rotor.

4. The sensor of claim 1, wherein a base is provided on the stator; the base comprises a bearing platform and a connecting frame arranged on the bearing platform; and the bearing platform is connected to an end face of the stator facing away from the rotor, and an end face of the bearing platform facing away from the stator is the mounting end face.

5. The sensor of claim 2, wherein a non-reflective area is provided between two adjacent reflective areas on the grating code disk; or a through hole is provided between two adjacent reflective areas on the grating code disc and a non-reflective area is provided in an area corresponding to the through hole on the mounting end face.

6. The sensor of claim 5, wherein the non-reflective area is formed by a blackening process or a paint blackening process.

7. The sensor of claim 1, wherein the rotating body comprises a support frame and a circuit system arranged on the support frame; the support frame is connected with the rotor; and the reading head assembly is arranged on the support frame and is electrically connected with the circuit system.

8. The sensor of claim 7, wherein the support frame comprises a middle connecting plate and a plurality of side plates arranged at opposite ends of the middle connecting plate; the motor is arranged between two opposite side plates of the plurality of side plates, and is fixedly connected to the middle connecting plate through the rotor; the reading head assembly is connected to one of the plurality of side plates; and at least one of sub-circuits is provided on the middle connecting plate and the plurality of side plates respectively, and the sub-circuits are coupled to each other to form the circuit system.

9. The sensor of claim 8, wherein a plurality of cooling fins is provided on a side surface of at least one of the plurality of side plates facing the motor.

10. The sensor of claim 7. wherein a wireless power supply assembly and a data transmission assembly are provided in the motor; the wireless power supply assembly is coupled to the data transmission assembly, the circuit system of the rotating body, and the reading head assembly, respectively, and supplies electric power to the data transmission assembly, the circuit system and the reading head assembly through wireless power supply; and the data transmission assembly is coupled to the circuit system of the rotating body and transmits data signals for the circuit system through wireless transmission.

11. The sensor of claim 1, wherein the reading head assembly comprises a mounting bracket, a reading head, and an electrical connector, the mounting bracket is connected to the rotating body, and the reading head is arranged on the mounting bracket and extends toward the extension direction of the rotation center line of the rotor and is electrically connected with the rotating body through the electrical connector.

12. The sensor of claim 11, wherein the mounting bracket comprises a first connecting plate and a second connecting plate, the first connecting plate is connected with the rotating body, the second connecting plate is connected to the first connecting plate at an angle and extends toward the extension direction of the rotation center line of the rotor, and the reading head is arranged on the second connecting plate.

13. The sensor of claim 11, wherein the mounting bracket comprises a through hole, one end of the electrical connector is connected to the reading head, and the other end of the electrical connector passes through the through hole and electrically connects to the rotating body.

14. The sensor of claim 1, wherein the sensor comprises a microwave radar, a millimeter wave radar, or a lidar.

15. The sensor of claim 1, wherein in a plan view, the grating code disk and the read head assembly are in a space within the stator.

16. A movable platform, comprising a movable platform body and a sensor provided on the movable platform body, wherein the sensor comprises:
a motor, the motor comprising a stator and a rotor rotatably connected to the stator, the stator having a mounting end face in an extension direction of a rotation center line of the rotor;
a rotating body, the rotating body being fixedly connected to the rotor; and
a grating sensor, the grating sensor comprising a grating code disc and a reading head assembly matched with the grating code disc,
wherein the grating code disc is disposed on the mounting end face of the stator, the reading head assembly is connected to the rotating body, and a position of the reading head assembly is opposite a position of the grating code disc; and
wherein the reading head assembly cooperates with the grating code disc to sense a rotation angle of the rotating body.

17. The sensor of claim 16, wherein in a plan view, the grating code disk and the read head assembly are in a space within the stator.

18. The movable platform of claim 16, wherein the movable platform comprises an unmanned aerial vehicle, an unmanned vehicle, or a movable robot.

19. A microwave radar sensor, comprising:
a motor comprising a stator and a rotor rotatably connected to the stator, the stator having a mounting end face in an extension direction of a rotation center line of the rotor;
a grating code disc disposed on the mounting end face of the stator and having a plurality of reflective areas spaced along a circumferential direction of the grating code disc;
a rotating body being fixedly connected to the rotor; and
a reading head assembly connected to the rotating body,
wherein a position of the reading head assembly is opposite a position of the grating code disk; and the reading head assembly cooperates with the grating code disc to sense a rotation angle of the rotating body.

20. The microwave radar sensor of claim 19, wherein in a plan view, the grating code disk and the read head assembly are in a space within the stator.
